(19) United States
(12) Patent Application Publication
(10) Pub. No.: US 2004/0236726 A1
(43) Pub. Date: Nov. 25, 2004

(54) System and method for query result caching

(75) Inventors: David B. Ewing, Huntsville, AL (US); Kevin R. Banks, Madison, AL (US); Rick A. Martindale, Huntsville, AL (US)

Correspondence Address: BAKER BOTTS L.L.P., 2001 ROSS AVENUE, SUITE 600, DALLAS, TX, 75201-2980, US

(73) Assignee: Teracruz, Inc., Madison, AL

(21) Appl. No.: 10/441,714

(22) Filed: May 19, 2003

(51) Int. Cl. G06F 17/30

(52) U.S. Cl. 707/3

(57) ABSTRACT

A method, performed in a result caching system, for query result caching comprises providing a query result database comprising at least one query result record, each query result record associated with a query, receiving from a requestor a query request intended for a server, and determining if the query request is represented by a query result record in the query result database. The method further comprises, responsive to determining that the query result record representing the query request is found in the query result database, retrieving and transmitting to the requestor a query response to the query request, wherein the query response is retrieved from the query result database, and responsive to determining that the query result record representing the query request is not found in the query result database, creating a new query result record representing the query request in the query result database and transmitting the query request to the server.

### BACKGROUND

1. Field

The present invention relates generally to database management systems and, in particular, to a system and method for enhancing the performance of database queries made to database management systems.

2. Description of the Related Art

Database management systems (DBMS) for large enterprise systems are built using a networked topology where database applications and the databases execute on distinct computing elements (servers) and communicate with each other over a network. Database programs, which are necessary to manage information for these enterprises, are rich in feature-set, support thousands of simultaneous accesses, and are generally complex. Accordingly, the database software merits high performance server hardware in order to provide a reasonable level of performance (database response time).

The database servers, while requiring a large amount of disk storage and computing power, are general purpose in nature in that, they are not necessarily optimized to run database software. The server hardware is typically selected based on factors such as storage capacity, number of processors, amount of main memory, and potential for expansion in the aforementioned factors.

Application servers are typically coupled to database servers via either 100BaseT Ethernet or Gigabit Ethernet. Application servers and database servers communicate across the network using high-level networking protocols, such as Transmission Control Protocol/Internet Protocol (TCP/IP). Further, depending on the database software vendor, the application servers and database servers communicate using database specific application layer protocols. The application layer protocol provides for user authentication, permission level management, application connection establishment, database queries, database query responses, and the like.

A typical DBMS is designed and structured to accept and respond to commands to store, retrieve, modify, and delete data. One commonly known and widely used application protocol that provides the aforementioned database commands is the Structured Query Language (SQL). For example, the application server can make requests and information updates using SQL commands that read and write database information.

In a typical DBMS, performance bottlenecks primarily result from inadequate or slow database response times. To cope with performance bottlenecks and to enhance or maintain the database performance at acceptable levels, a DBMS manager typically either repartitions the database in such a way as to make use of additional database servers, or upgrades the existing database servers by adding storage, main memory, or additional processors, or otherwise replaces the existing servers with one or more other servers of higher performance. These methods of maintaining or enhancing database performance, in addition to being very costly and time consuming, are only temporary until the demands placed on the additional or enhanced database servers outstrip the servers' ability to provide reasonable response times. Thus, there exists a need to increase database performance without having to incur the costs associated with the aforementioned, conventional methods of maintaining or enhancing database performance.

### SUMMARY

In one embodiment, a method, performed in a result caching system, for query result caching comprises a query result database comprising at least one query result record, each query result record associated with a query, receiving from a requestor a query request intended for a server, and determining if the query request is represented by a query result record in the query result database. The method further comprises, responsive to determining that the query result record representing the query request is found in the query result database, retrieving and transmitting to the requestor a query response to the query request, wherein the query response is retrieved from the query result database, and responsive to determining that the query result record representing the query request is not found in the query result database, creating a new query result record representing the query request in the query result database and transmitting the query request to the server.

In another embodiment, a computer-readable storage medium has stored thereon computer instructions that, when executed by a computer, cause the computer to receive from a requestor a query request intended for a server, determine if the query request is represented by a query result record in a query result database, wherein the query result database comprises at least one query result record, each query result record associated with a query, responsive to determining that the query result record representing the query request is found in the query result database, retrieve and transmit to the requestor a query response to the query request, wherein the query response is retrieved from the query result database, and responsive to determining that the query result record representing the query request is not found in the query result database, create a new query result record representing the query request in the query result database and transmit the query request to the server.

In still another embodiment, a result caching system comprises a means for providing a query result database comprising at least one query result record, each query result record associated with a query, a means for receiving from a requester a query request intended for a server, a means for selectively determining whether to check to see if the query request is represented by a query result record in the query result database based on the query request, responsive to determining that the query result record representing the query request is found in the query result database, a means for retrieving and transmitting to the requestor a query response to the query request, wherein the query response is retrieved from the query result database, and responsive to determining that the query result record representing the query request is not found in the query result database or responsive to determining not to check to see if the query request is represented by a query result record in the query result database based on the query request, creating a new query result record representing the query request in the query result database and transmitting the query request to the server.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The following drawings incorporated in and forming a part of the specification illustrate, and together with the detailed description serve to explain various aspects of the implementation(s) and/or embodiment(s) of the invention and not of the invention itself.

FIG. 1 is a block diagram illustrating an exemplary environment in which a result caching system of the present invention may operate.

FIG. 2 is a block diagram illustrating one embodiment of the exemplary components of a result caching system, according to the present invention.

FIG. 3 is a block diagram illustrating one embodiment of a communications flow between a database client, a result caching system, and a database in processing a query and building a cache entry for the query.

FIG. 4 is a representation of one embodiment of a caching hierarchy.

FIG. 5 is a representation of one embodiment of a cache database record in a cache database.

FIG. 6 is a block diagram illustrating one embodiment of a communications flow between a database client and a result caching system in processing a query by the result caching system.

FIG. 7 is a block diagram illustrating one embodiment of the relationships between database clients, result caching system handlers, and database listeners.

FIG. 8 illustrates a flow chart of one embodiment of a method by which a result caching system instantiates a handler to process a message received from a database client.

FIG. 9 illustrates a flow chart of one embodiment of a method by which a handler processes a message received from a database client.

FIG. 10 illustrates a flow chart of one embodiment of a method by which a handler creates an entry in a cache database for a database query operation.

### DETAILED DESCRIPTION

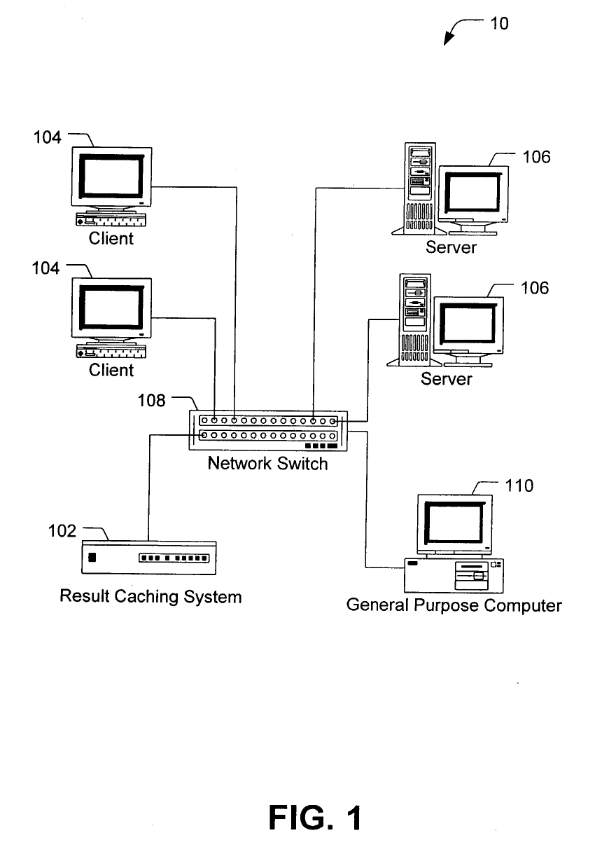

The various embodiments of the present invention and their advantages are best understood by referring to FIGS. 1 through 10 of the drawings. The elements of the drawings are not necessarily to scale, emphasis instead being placed upon clearly illustrating the principles of the invention. Throughout the drawings, like numerals are used for like and corresponding parts of the various drawings.

Turning first to the nomenclature of the specification, at least one embodiment described in the detailed description that follows is presented largely in terms of processes and symbolic representations of operations performed by computers, including computer components. A computer may be any microprocessor or processor (hereinafter referred to as processor) controlled device capable of enabling or performing the processes and functionality set forth herein. The computer may possess input devices such as, by way of example, a keyboard, a keypad, a mouse, a microphone, or a touch screen, and output devices such as a computer screen, printer, or a speaker. Additionally, the computer includes memory such as, without limitation, a memory storage device or an addressable storage medium.

The computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors (i.e., computers). The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic can be maintained or stored on a computer-readable storage medium. The term “computer-readable storage medium” refers to any medium that participates in providing the symbolic representations of operations to a processor for execution. Such media may take many forms, including, without limitation, volatile memory, nonvolatile memory, flash memory, electronic transmission media, and the like. Volatile memory includes, for example, dynamic memory and cache memory normally present in computers. Nonvolatile memory includes, for example, optical or magnetic disks.

It should also be understood that the programs, modules, processes, methods, and the like, described herein are but exemplary implementations and are not related, or limited, to any particular computer, apparatus, or computer language. Rather, various types of general-purpose computing machines or devices may be used with programs constructed in accordance with the teachings described herein. Similarly, it may prove advantageous to construct a specialized apparatus to perform some or all of the method steps described herein by way of dedicated computer systems with hard-wired logic or programs stored in non-volatile memory, such as, by way of example, read-only memory (ROM).

FIG. 1 illustrates a block diagram illustrating an exemplary environment 10 in which a result caching system 102 of the present invention may operate. In one embodiment, environment 10 comprises a networked database system. The networked database system provides a networked environment in which database clients and database servers can communicate, typically through a hub or network switch.

As depicted, environment 10 comprises result caching system 102, at least one client 104, and at least one server 106 each coupled to a network switch 108. As used herein, the terms “connected,” “coupled,” or any variant thereof, means any connection or coupling, either direct or indirect, between two or more elements; the coupling or connection between the elements can be physical, logical, communicative, or a combination thereof.

In one embodiment, the networked database system comprises a database management system. For example, at least one server 106 can host the database management system server software, and a user can execute a database client software on a client 104 to interact with the database management system. Network switch 108 generally functions to provide the interconnection for the networked database system infrastructure. Even though each client 104 and server 106 is shown coupled to the same network switch 108, it is appreciated that a client 104 that is coupled to a different hub or network switch can communicate with the networked database system and, in particular, the database management system executing within the database network computer system.

Typically, and as is generally known, information is exchanged between database clients (i.e., client 104) and database servers (i.e., server 106) based on relationships that are configured by a network or database system administrator. For example, the database system administrator builds a database system with computer hardware and software that is optimized at various levels within the database system. Accordingly, the database client and server hardware and software may be different to meet desired performance criteria while maintaining costs. These differences are implemented on a homogeneous network, but clients and servers are configured to implement or achieve client/server pairings (i.e., client-server relationships). Once the database system administrator determines the client/server pairings that satisfy the desired requirements, the database system administrator configures these relationships by “pointing” clients to servers using client configuration files.

Result caching system 102 implements and incorporates the various aspects of the present invention. In particular, one or more software components or programs that embody the various aspects of the present invention execute on result caching system 102. In one embodiment, result caching system 102 generally functions to receive network packets from a client 104 intended for a particular server 106. Result caching system 102 inspects the network packets to determine if the network packets are relevant for caching, and either caches the network packets or forwards the network packets to the intended server 106 in the case of client 104 to server 106 packets, or forwards the network packets to an appropriate client 104 in the case of server 106 to client 104 packets.

Result caching system 102 requires a network infrastructure that ensures that the desired client/server network traffic is routed through result caching system 102. Configuring a network infrastructure to route desired client/server network traffic through an intermediate node, such as result caching system 102, is generally known to those of ordinary skill in the relevant art. By way of example, clients 104 can be configured to address their server traffic (i.e., requests intended to be serviced by a server 106) to an Internet Protocol (IP) address of result caching system 102. For example, client 104 can maintain or store this configuration information in a configuration file. Result caching system 102 can then cache and/or forward the received server traffic as disclosed herein. Moreover, client traffic from servers 106 intended for clients 104 can be routed through result caching system 102, allowing result caching system 102 to perform any necessary processing as also disclosed herein. As depicted in FIG. 1, network switch 108 is configured to perform the IP address routing such that the appropriate client/server network traffic is routed through result caching system 102 as configured in, for example, the configuration files of clients 104.

Result caching system 102 may or may not have input/output ports suitable for connecting devices such as, by way of example, a keyboard, a mouse, and/or a video device. For example, a user, such as a database system administrator, can use one or more such connected devices to configure result caching system 102 to enable and/or disable caching and to otherwise interact with result caching system 102 (e.g., access caching statistics, access diagnostic information/data, etc.). Typically, and as depicted in FIG. 1, result caching system 102 does not have input/output ports for connecting such input/output devices because large enterprise computer systems are typically implemented in rack-mount configurations, and in these configurations it is advantageous to share keyboard/video resources to conserve space. In these configurations, result caching system 102 can provide access via a supported network connection through, for example, network switch 108.

In one embodiment, result caching system 102 supports administration network connectivity through an IP address. A database system administrator can then execute an Internet browser or other suitable client software on general-purpose computer 110 to access the IP address of result caching system 102. Once accessed, result caching system 102 detects whether the browser software executing on general-purpose computer 110 supports the Java™ run-time environment. If the Java™ run-time environment is not supported, result caching system 102 requests that the user downloads the Java™ run-time environment before accessing result caching system 102.

If the Internet browser executing on general-purpose computer 110 supports the Java™ run-time environment, result caching system 102 downloads a Java™ panel (Java program) onto general-purpose computer 110 for execution on general-purpose computer 110. The Java™ panel is an implementation of the client software that generally functions to authenticate a user, request and receive result caching system 102 configuration information, provide caching statistical information as well as other performance data, and enable/disable caching for queries intended for servers 106. By way of example, in the networked database system, caching can be enabled/disabled for queries affecting a set of one or more database servers, one or more databases, one or more database clients, one or more database users, and one or more database tables. It is appreciated that the client software need not be implemented as a Java™ panel but can also be implemented using other generally known programming languages and techniques.

As depicted in FIG. 1, general-purpose computer 110 is coupled to network switch 108. In addition to functioning as a device suitable for accessing result caching system 102 and displaying caching configuration information, a database system administrator can use general-purpose computer 110 to configure and manage result caching system 102 and, in particular, network switch 108 as is generally known to one of ordinary skill in the art. The database system administrator can also use general-purpose computer 110, or another suitable computing device (not shown), to configure result caching system 102 to gather or generate certain types of cache statistics.

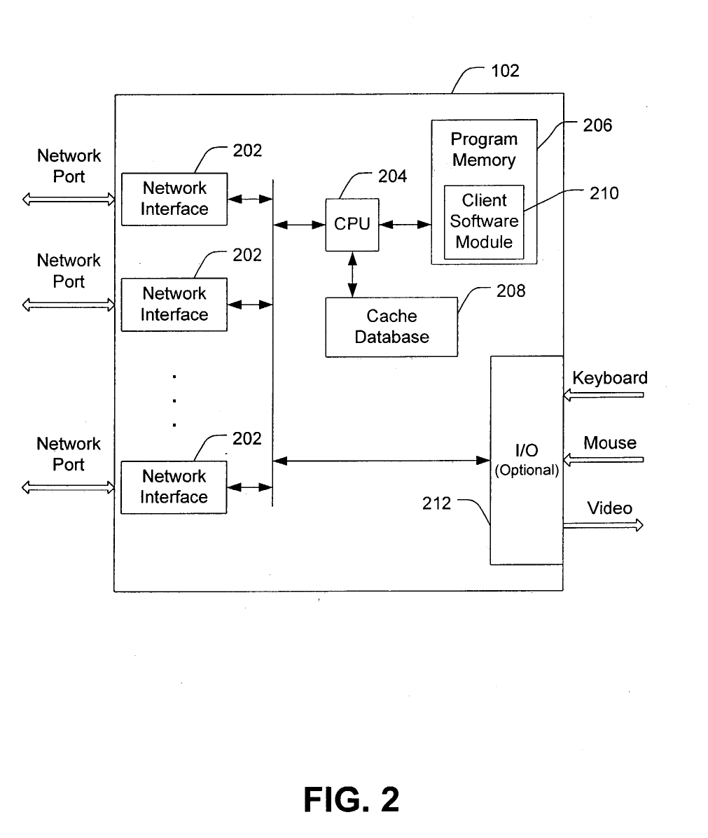

FIG. 2 illustrates a block diagram of exemplary components of one embodiment of result caching system 102, according to the present invention. Result caching system 102 comprises at least one network interface 202 coupled to a central processing unit (CPU) 204. Each network interface 202 supports and functions as a network port.

In one embodiment, the network ports are Ethernet ports and network interfaces 202 are essentially subsystems that comprise a connector, interface electronics, a network Media Access Controller (MAC), and a network PHY module or chip that interfaces the wire to the MAC (the PHY module makes the signal on the physical wire understandable to the MAC, and visa versa). Typically, network interface 202, including most of the aforementioned components comprising network interface 202 is embodied in what is generally referred to as an Ethernet Controller. In one embodiment, the Ethernet Controller comprises Ethernet software, which is implemented using Linux Ethernet drivers. It is appreciated that network interface 202 can support other types of network ports, such as, by way of example and not limitation, FibreChannel, Infiniband, and FDDI.

Typically, the network controller (i.e., network interface 202) also comprises a Direct Memory Access Controller (DMAC) that is programmed to deliver received network packets directly from the network port (i.e., Ethernet port) to memory. The network controller vendor usually delivers the network controller in the form of an operating system network interface driver. The driver software configures the network controller to receive and send network packets, store received packets directly into memory, and transmit packets by configuring the internal DMAC to retrieve network packets directly from memory for transmission by the network controller.

CPU 204 is the controlling center for result caching system 102 and generally functions to provide conventional processing facilities for initial program loading, program instruction execution, interrupt processing, timing functions, and other machine and computer-related functions. In one embodiment, CPU 204 executes the Linux operating system, which is used to control the operation of the computing environment within result caching system 102 by controlling the execution of programs (including communication protocols), controlling communication with network interfaces 202, controlling communication with peripheral devices, and controlling the use of result caching system 102 resources.

As depicted in FIG. 2, result caching system 102 also comprises a program memory 206 and a cache database 208 each coupled to CPU 204. Program memory 206 and cache database 208 are computer-readable storage media. In one embodiment, program memory 206 is implemented as a flash module, which is programmed with software that enables result caching system 102 to function as disclosed herein.

Program memory 206 comprises a client software module 210. In one embodiment, client software module 210 is the aforementioned Java™ panel that is downloaded onto and executed on a remote computer. When executed, client software module 210 allows a user at the remote computer to connect to result caching system 102 and access the features provided by result caching system 102 including, without limitation, enabling/disabling caching, accessing cache statistics, and the like. In this embodiment, result caching system 102 provides web-server or other network-server software that allows the remote computer to connect to, interact with, and administer result caching system 102.

In another embodiment, client software module 210 is a client program that is executed on result caching system 102, for example, by CPU 204. For example, a user can use a terminal-like device that is coupled to result caching system 102 and execute client software module 210 to provide configuration data to enable result caching system 102 to cache appropriate client/server network packets.

In one embodiment, cache database 208 is implemented as random access memory (RAM) and generally functions to maintain data within result caching system 102. Examples of such data include, without limitation, variables used by the operating system, network packets, configuration information, and cache statistics.

Also coupled to CPU 204 is an I/O 212. I/O 212 is optional, and generally functions to provide connectivity to peripheral devices such as a keyboard, a mouse, and/or audio/video devices. For example, a user may connect a terminal to I/O 212 and access and execute programs on result caching system 102, including client software module 210.

The aforementioned components of result caching system 102 are only illustrative and result caching system 102 may comprise other components and modules not depicted. The depicted components and modules may communicate with each other and other components comprising result caching system 102 through mechanisms such as, by way of example, direct memory access, interprocess communication, procedure and function calls, application program interfaces, other various program interfaces, and various network protocols. Furthermore, the functionality provided for in the components and modules may be combined into fewer components or modules or further separated into additional components or modules.

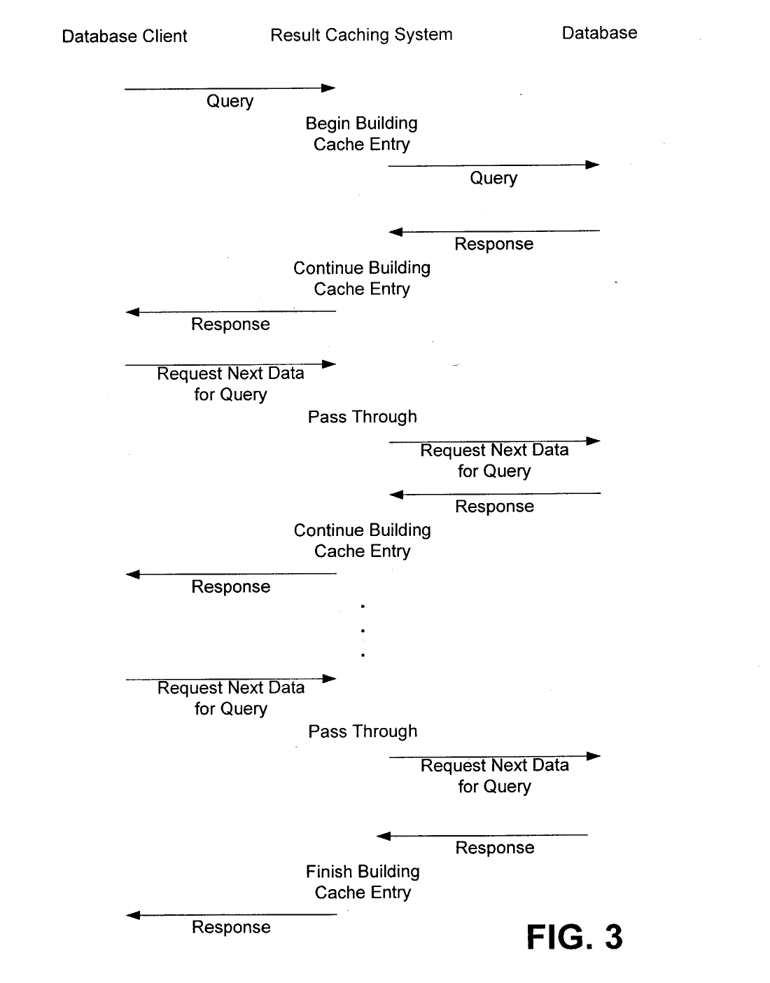

FIG. 3 is a block diagram illustrating one embodiment of a communications flow between a database client, result caching system 102, and a database in processing a query and building a cache entry for the query. The database client can be a database application server software executing on one or more clients 104. The database application software provides access to the database, which can be accessed through a database management system software executing on one or more servers 106.

The database client (i.e., the database application software) interacts with the database (i.e., the database management system software executing on the database server) through the exchange of one or more database messages. As is generally known, a “database message” comprises an appropriate database application protocol (i.e., Structured Query Language (SQL)) supported and used by the database client and the database to communicate with each other. In a networked environment, one or more underlying network protocols are used to deliver the database messages to and from the database client and the database.

In one embodiment, a user, such as a database administrator, configures the database client and, in particular, the database application server software to address database messages intended for a database and, more particularly, the database server that provides access to the database, to the IP address of result caching system 102. The user also configures result caching system 102 to accordingly forward the received database messages to its intended database server (i.e., the IP address of the server 106 that the database management system executes on) upon determining a need to do so as disclosed herein.

For example, result caching system 102 forwards a received database message to the intended database server upon determining that it is unable to enhance the database system performance by appropriately responding to the database message without utilizing the processing services provided by the database server. In this manner, appropriate database messages, as determined by the configuration information, are routed to result caching system 102 instead of being delivered directly to the intended database server as determined by the accessed database. It is appreciated that the user can selectively configure the routing of database messages. For example, database messages from certain database clients and/or database messages intended for certain database servers can be routed through result caching system 102 while database messages to and from other database clients and/or database servers are not routed through result caching system 102.

Returning to FIG. 3, a database administrator may have previously configured the database client to route all database messages intended for the database through result caching system 102. With this configuration, result caching system 102 receives a database message and parses enough of the database message to determine that the database message is a query request (i.e., an SQL read request). Result caching system 102 then determines whether caching is enabled for the received query.

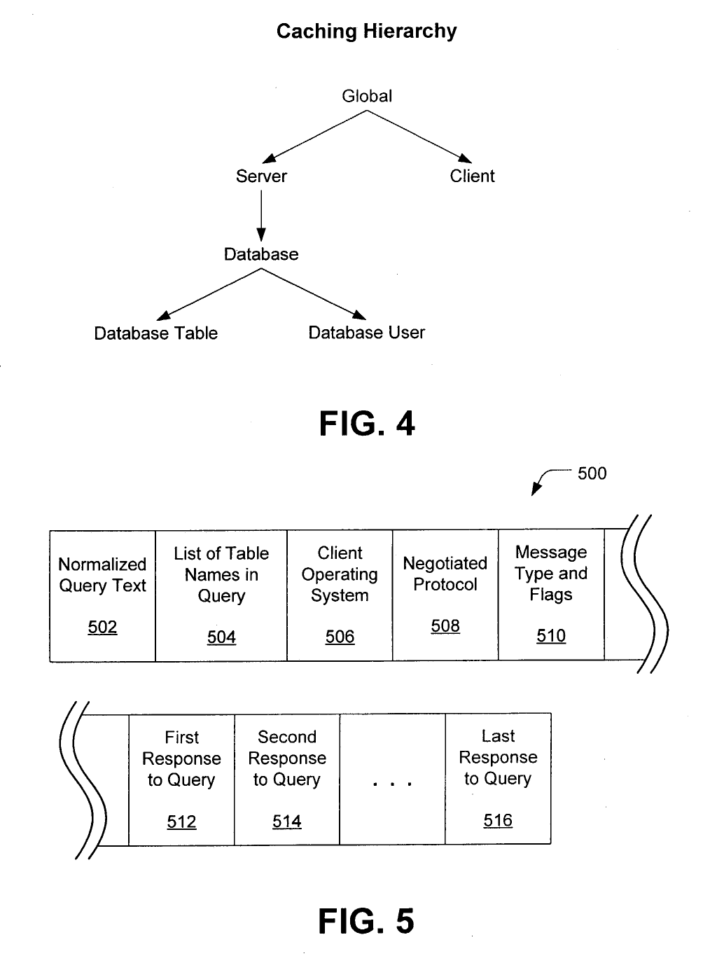

In one embodiment, result caching system 102 is configurable to selectively cache query requests. For example, the database administrator can configure result caching system 102 to cache query requests based on a caching hierarchy. FIG. 4 is a representation of one embodiment of the caching hierarchy that is suitable to determine the caching characteristics of result caching system 102.

As depicted in FIG. 4, at the highest level of the caching hierarchy is a “global” designator that indicates whether or not caching is enabled or disabled in result caching system 102. Next in the hierarchical level below “global” is a “server” designator that identifies a list of database servers for which caching is enabled and a “client” designator that identifies a list of clients for which caching is enabled. Next in the hierarchy below “server” is a “database” designator that identifies a list of databases for which caching is enabled. Next in the hierarchy below “database” is a “database table” designator that identifies a list of database tables for which caching is enabled and a “database user” designator that identifies a list of database users for which caching is enabled.

For caching to be enabled within result caching system 102, the “global” designator needs to be enabled (e.g., set to a “on” or “yes” state). If the “global” designator is not enabled, irrespective of the state or contents of the other designators in the caching hierarchy, result caching system 102 will not attempt to optimize or enhance the performance of the database system by attempting to cache received query requests.

The remaining designators in the caching hierarchy are used to configure result caching system 102 to selectively cache query requests based on the specific designators. The “server” designator is used to configure result caching system 102 to selectively cache query requests based on the intended database server. For example, to configure result caching system 102 to cache query requests intended for a specific database server, the particular database server needs to be identified in the database server list associated with the “server” designator. Stated another way, result caching system 102 will attempt to a cache query request intended for a database server only if the intended database server is designated in the database server list associated with the “server” designator.

Similarly, the “database” designator is used to configure result caching system 102 to selectively cache query requests based on the intended database, the “user” designator is used to configure result caching system 102 to selectively cache query requests based on the requesting database user, the “client” designator is used to configure result caching system 102 to selectively cache query requests based on the requesting database client, and the “table” designator is used to configure result caching system 102 to selectively cache query requests based on the database table being queried. Similar to the operation of the “server” designator, for each of the aforementioned designators, result caching system 102 will attempt to cache a query request only if the query request is intended for a database that is designated in the database list, the query request is made by a database user that is designated in the database user list, the query request is made by a database client that is designated in the database client list, and the query request is a query of a database table that is designated in the database table list.

If any one of the database server, database, database user, database client, and database table associated with a query request is not designated (not found or identified) in the respective list, result caching system 102 will not attempt to cache the query request. Stated another way, in addition to the “global” designator being enabled, the database server, database, database user, database client, and database table associated with a query request all needs to be designated in their respective lists in order for result caching system 102 to cache the query request. By providing the caching hierarchy and, in particular, the ability to designate elements of the database system in the caching hierarchy, the database administrator is able to quickly and easily activate/deactivate caching within result caching system 102. It is appreciated that result caching system 102 can incorporate and provide a caching hierarchy composed of a different combination of designators and/or a different ordering of the same or different designators than that illustrated in FIG. 4.

Referring again to FIG. 3, assuming that result caching system 102 determines that the received query is to be cached, for example, based on the query and the aforementioned caching hierarchy, and that the query is not found in cache database 208, result caching system 102 begins building or creating a cache entry in cache database 208 for the query.

In one example, result caching system 102 may not be able to find the query in cache database 208 if this query is being routed to result caching system 102 for the first time. In another example, result caching system 102 may not be able to find the query in cache database 208 if, previous to receiving this query, result caching system 102 detected an update of one or more database tables accessed or requested by this query and subsequently invalidated or removed the entry associated with the received query in or from cache database 208. In still another example, result caching system 102 may not be able to find the query in cache database 208 if the entry associated with the query was removed from cache database 208 based on, for example, conventionally known aging criteria (e.g., inactivity, non-use, etc.).

FIG. 5 is a representation of one embodiment of a cache database record 500 entry in cache database 208. Each cache database record 500 in cache database 208 represents a cached query and corresponding query result. Upon failing to find a cache database record 500 representing or associated with the query, result caching system 102 begins building a cache database record 500 for the query in cache database 208. By way of example, eight fields are illustrated comprising a normalized query text field 502, a list of table names in query field 504, a client operating system field 506, a negotiated protocol field 508, a message type and flags field 510, a first response to query field 512, a second response to query field 514, and a last response to query field 516.

Normalized query text field 502 contains the query text “normalized” by removing the intervening “spaces” in the query and capitalizing all the letters in the query. Normalized query text field 502 functions as a “tag” for the corresponding cache database record 500 in query database 204. Result caching system 102 uses this tag to determine whether there is a “cache hit” (i.e., the query is found in query database 204) or a “cache miss” (i.e., the query is not found in query database 204).

List of table names in query filed 504 contains a list of table names accessed or read by the query. Client operating system field 506 identifies the particular operating system and version that is executing on the database client that made the query. One example of a client operating system and version is “Windows 2000, v.2.0”. Negotiated protocol field 508 identifies the particular database protocol and version, for example “Oracle 8.1.7.4.0”. Message type and flag field 510 identifies the message format used within the negotiated protocol. The flags are those sent by the database client to indicate SQL statement boundaries, and protocol variations.

First response to query field 512 contains the first response to the query that is made by the database. Second response to query field 514 contains the second response to the query that is made by the database. Last response to query field 516 contains the last response to the query that is made by the database. The last response to query field 516 contains a “last response” indicator. The “last response” indicator is part of the message protocol and functions to inform the database client that this response to query (that this response) is the last response.

In one embodiment, each of the aforementioned responses to the query are the corresponding network packets composed of the database application protocol and any underlying network protocols transmitted by the database and the database server and received by result caching system 102. It is appreciated that cache database record 500 may comprise a different number of response to query fields, and that the actual number of response to query fields in cache database record 500 is dependent on the actual query represented by cache database record 500.

It is further appreciated that, for this and other records described or implemented herein, any number of the fields may be broken down into additional sub-fields, that additional fields can be added, and that any of the fields may be implemented as pointers to other fields or other data records. For example, in other embodiments, cache database record 500 can be further composed of, without limitation, one or more of the following fields: a valid/invalid field, a time stamp field, and a last time accessed field.

Result caching system 102 can indicate whether or not cache database record 500 is valid or invalid in the valid/invalid field. By using such a field to indicate the validity of cache database record 500, an invalid (i.e., no longer valid) cache database record 500 does not need to be removed from cache database 208. This may serve advantageous in generating and providing statistical and historic information concerning the caching activities performed by result caching system 102.

The time stamp field can record the time cache database record 500 was created in cache database 208. The last time accessed field can record the time cache database record 500 was last accessed. Result caching system 102 can use the recorded times in these fields to remove cache database records 500 from cache database 208 based on criteria such as age, time of last access, etc. This is advantageous where cache database 208 is limited in the number of cache database records 500 it can maintain or store.

Referring again to FIG. 3, result caching system 102 begins building a cache database record 500 for the query in cache database 208 by normalizing the query text and storing the normalized query text in normalized query text field 502. Result caching system 102 then parses enough of the query text to determine the one or more table names accessed by the query, the client operating system, and message type and flags and stores this information in their respective fields in cache database record 500. Result caching system 102 then forwards the query to the intended database.

More particularly, result caching system 102 transmits the database message (i.e., the query) to a database server that provides access to the intended database. Result caching system 102 subsequently receives a response message to the recently transmitted database message from the database server.

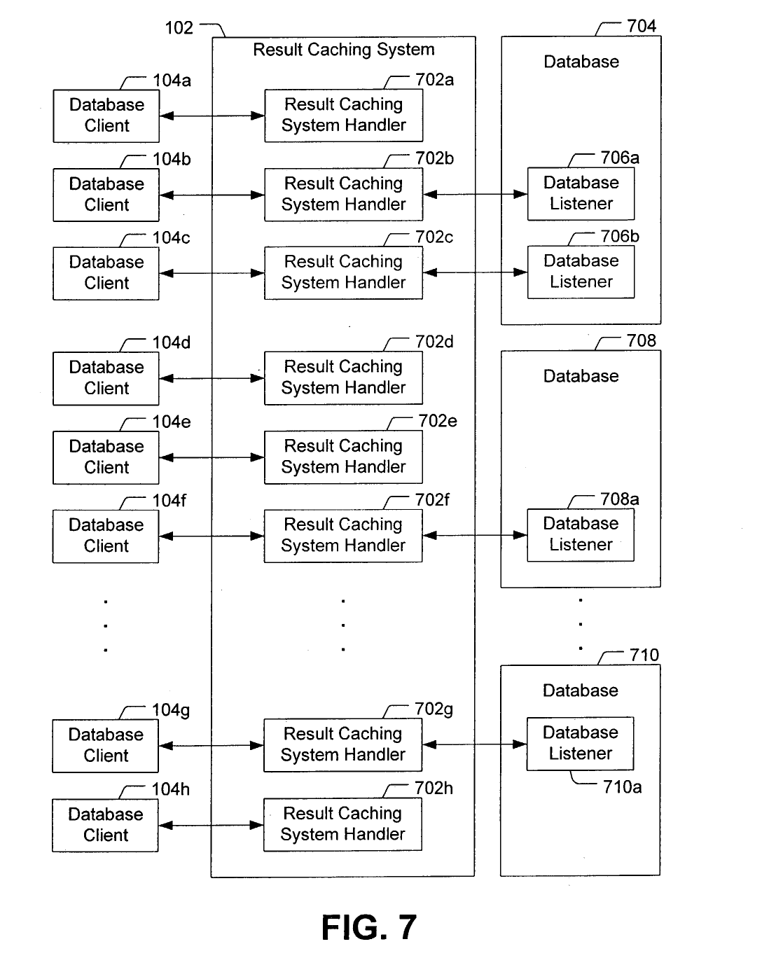

In one embodiment, for each database message, result caching system 102 executes an instance of a software handler (i.e., a software process) to handle or process the received database message. In this embodiment, because each software process is handling a single database session, each software process is able to readily associate the database request message to its response message as well as maintain the necessary addressing and cache database record 500 information. This implementation is further discussed below in conjunction with FIG. 7.

In another embodiment, a software process executing within result caching system 102 can be programmed to handle multiple simultaneous database request messages. In this embodiment, the software process may need to maintain additional information for each database request message being processed and parse portions of the received database request messages and response messages in order to properly pair a received response message to its proper and original database request. These programming techniques are generally known to those of ordinary skill in the relevant art.

In still another embodiment, a software process executing within result caching system 102 can be programmed to handle multiple simultaneous database request messages in a single client/server session. In this embodiment, the software process may need to maintain additional information for each database request message being processed and parse portions of the received database request messages and response messages in order to properly pair a received response message to its proper and original database request within the session, referred to as concurrent messages. These programming techniques are generally known to those of ordinary skill in the relevant art.

Result caching system 102 associates the received response message from the database server with the database request message that was previously transmitted to the same database server. Result caching system 102 stores a copy of the response message in first response to query field 512 in cache database record 500. Result caching system 102 then forwards the response message to the requesting database client (i.e., the database client that previously made the query request).

Subsequent to forwarding the response message to the requesting database client, result caching system 102 may receive a database message requesting the next data or items of data from the database client. This can occur in instances where the data requested in the original or previous query was too large to be transmitted in a single response message or the prior response messages. Result caching system 102 passes the received database request messages to the intended database and subsequently receives a response message. Result caching system stores a copy of the response message in the appropriate response to query field (e.g., the second response to query field 514 if the response message was a response to a second query, etc.) in cache database record 500 and forwards the response message to the requesting database client.

Result caching system 102 processes database request messages requesting subsequent data or items of data in like manner until it has processed a database message requesting the last or final items of data associated with the original query. Those of ordinary skill in the art will realize that if the data or information requested in a single query is provided in a single response message, the database client will not transmit subsequent requests for additional data.

A technical advantage is that, by caching the response messages to a database query, result caching system 102 is able to properly respond to a subsequent database query that matches the prior database query without having to use the resources of the intended server. The cached responses are the actual responses made by the intended database server, thus, the originator of the database query (i.e., the database client) receives from result caching system 102 a response message identical to a response message it would have received if it was communicating directly with the database server (i.e., the query was not being cached by result caching system 102). Furthermore, result caching system 102 is able to provide the significant enhancement in performance without executing any database management system software or maintaining a copy of the database or portions of the database.

It is appreciated that the some or all of the aforementioned processing performed by result caching system 102 to build a cache entry for a received query may be performed in differing order. For example, result caching system 102 may forward a received query to its intended database prior to creating a cache database record 500 for the query in cache database 208.

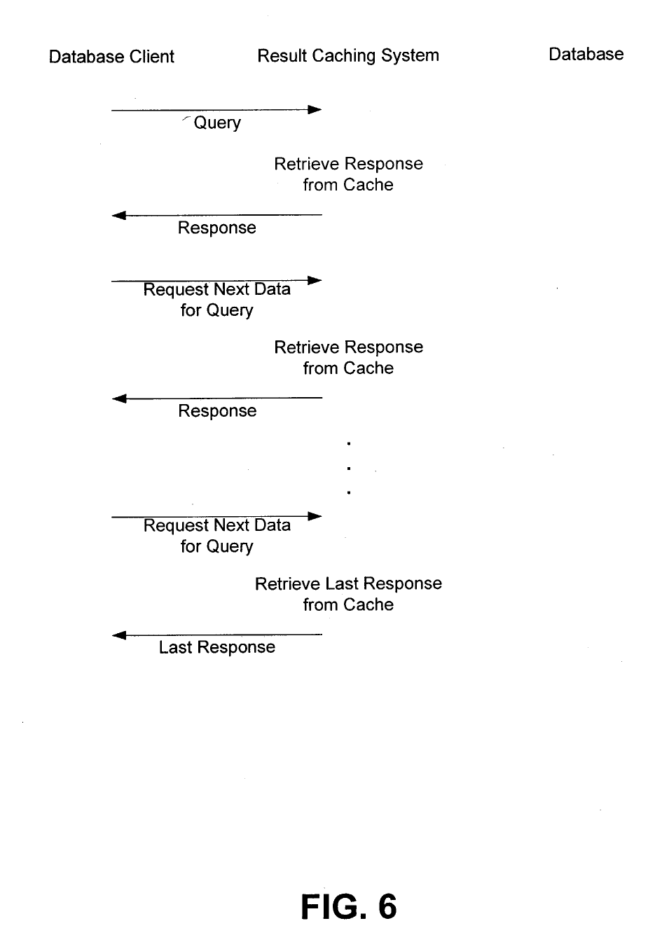

FIG. 6 is a block diagram illustrating one embodiment of a communications flow between a database client and result caching system 102 in processing a query by result caching system 102. A database administrator may have previously configured the database client to route all database messages intended for the database through result caching system 102. With this configuration, result caching system 102 receives a database message and parses enough of the database message to determine whether the database message is a query request. Result caching system 102 then determines from the caching hierarchy and the query request whether caching is enabled for the received query.

Assuming result caching system 102 determines that the received database message is a query and that caching is enabled for the query, result caching system 102 normalizes the query text and compares the normalized query text with the tags of cache database records 500 in cache database 208 to determine if there is a cache hit (i.e., whether the received query is found in the cache database 208).

Upon detecting a cache hit, result caching system 102 retrieves the response appropriate for the query from cache database record 500 and transmits the retrieved response to the requesting database client. For example, if the query request was the first request, result caching system 102 retrieves the contents of first response to query field 512 and transmits the retrieved contents to the requesting database client.

Result caching system 102 may receive a subsequent request for data if the first response to the query was unable to provide all of the data requested in the query. For example, the first response may have indicated that there is additional information to the database client. In response, the database client may have transmitted a request for the additional data. Upon receiving this request, result caching system 102 retrieves the next response to send (e.g., the contents of second response to query field 514) and transmits the response to the requesting database client. This procedure is repeated until all the data requested in the original query is sent to the requesting database client.

FIG. 7 is a block diagram illustrating one embodiment of the relationships between database clients, result caching system handlers, and database listeners. In particular, FIG. 7 illustrates the relationships between result caching system handlers 702 and the database clients 104 and database listeners 706. A master listener process (not depicted) executes on result caching system 102 and generally functions to listen for and receive incoming messages. For example, the master listener may listen for and receive SQL messages on port number 1521.

Upon receiving a message, the master listener process instantiates an instance of a result caching system handler and passes the received message to the just instantiated handler for further processing. The master listener process then resumes listening for other incoming messages. In one embodiment, the result caching system handler is a software process that functions to processes the message as disclosed herein, and upon processing the message, stops executing. The handler is able to easily sequence and match requests to responses.

As depicted in FIG. 7, handler 702a is processing a message received from database client 104a. In processing the message, handler 702a may have determined that the message was a query request that was cached within result caching system 102 and is accordingly responding to the query request by retrieving the previously stored response or responses and transmitting the response to database client 104a. Likewise, handler 702d is processing a message received from database client 104d, handler 702e is processing a message received from database client 104e and handler 702h is processing a message received from database client 104h. Furthermore, the received messages may be intended for different databases (i.e., query requests for data in different databases).

Also depicted in FIG. 7, handler 702b is processing a message received from database client 104b. Handler 702b may have determined that the message was a query request for data in database 704 and, furthermore, may have determined that there was a cache miss or, alternatively, that the message was not a query request. In this instance, and as illustrated in FIG. 7, handler 702b may communicate with a database listener process 706a in database 704 to appropriately process the message. If caching is enabled, process 702b may be creating an entry in caching the response to the message in cache database 708. Likewise, processes 702c, 702f, and 702g are processing messages received from database clients 104c, 104f, and 104g, respectively, by communicating with database listener processes 706b, 708a, and 710a, respectively. Again, the received messages may be messages intended for different databases as illustrated in FIG. 7.

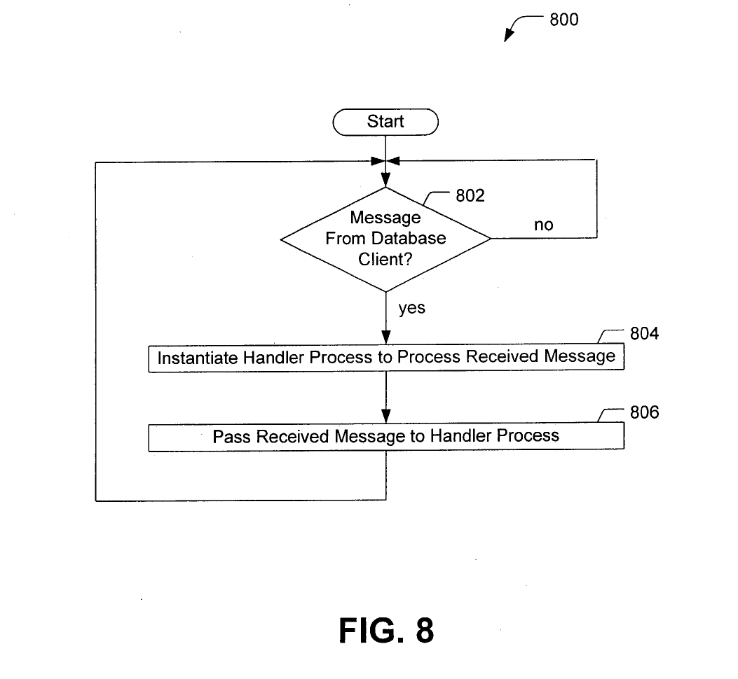

FIG. 8 illustrates a flow chart of one embodiment of a method 800 by which result caching system 102 instantiates a handler to process a message received from a database client. During a start step, a master listener process executes within result caching system 102 and listens for incoming database messages. At step 802, the master listener process checks to determine if a database message is received from a database client. In another process, the master listener process may be interrupted (i.e., awoken) once an incoming database message from a database client is detected.

If the master listener process does not receive a database message from a database client, the master listener process continues to listen for an incoming database message. In one embodiment, the master listener process may sleep or wait for a predetermined amount of time before rechecking to see if a database message was received from a database client.

If, at step 802, the master listener process receives a database message from a database client, the master listener process instantiates a handler to process the received database massage at step 804. At step 806, the master listener process passes to the just started handler the received database message for processing and continues to listen for other incoming database messages. In addition to the received database message, the master listener process may also pass additional information as necessary to the started handler to enable the handler to appropriately process the received database message. For example, if the master listener process performed any preprocessing of the received database message, the master listener process may pass to the handler the information derived from preprocessing the database message.

Those of ordinary skill in the art will appreciate that, for this and other methods disclosed herein, the functions performed in the exemplary flow charts may be implemented in differing order. Furthermore, steps outlined in the flow charts are only exemplary, and some of the steps may be optional, combined into fewer steps, or expanded into additional steps without detracting from the essence of the invention.

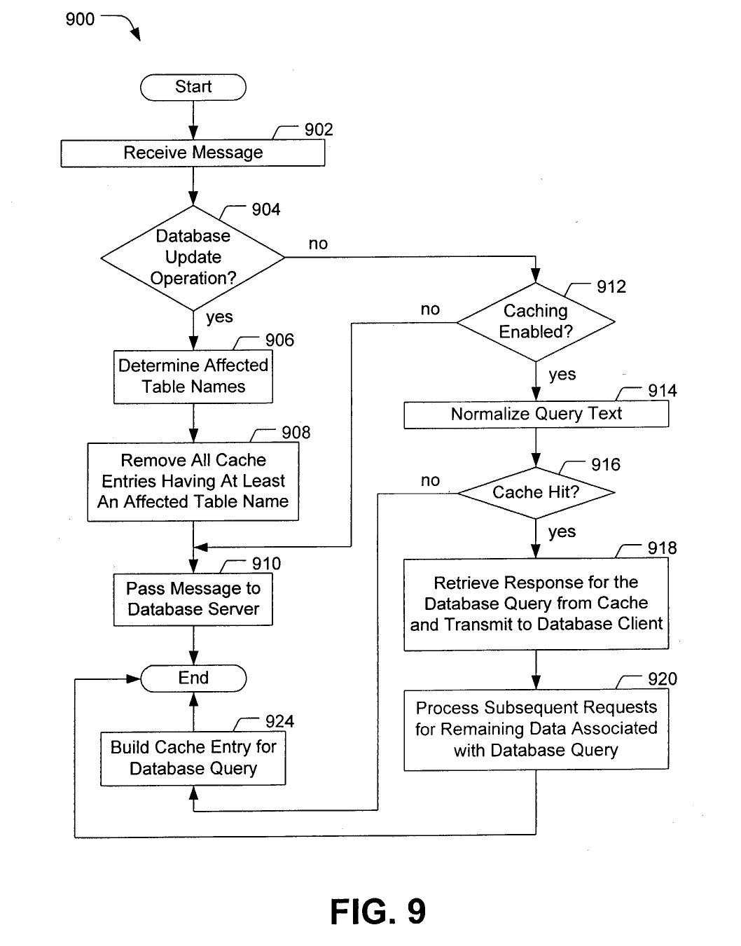

FIG. 9 illustrates a flow chart of one embodiment of a method 900 by which a handler processes a database message received from a database client. During a start step, a master listener process executing within result caching system 102 may have received a database message from a database client and instantiated an instance of the handler to further process the received database message. At step 902, the just instantiated handler receives the database message from, for example, the master listener process. At step 904, the handler checks to determine if the database message is a database update operation (i.e., a database write operation, other database operations that change or update data maintained by the database, a non-query operation, etc.).

If, at step 904, the handler determines that the database message is an update operation, the handler determines the affected table names at step 906. For example, the handler can parse enough of the database message to determine if it is a database update operation and, if it is an update operation, the handler can further parse the database message to determine the names of the tables that are being updated.

At step 908, the handler removes all cache entries having at least one of the affected table names. These cache entries are removed because the responses stored as part of these cache entries may no longer be valid responses because of the database update operation (the update to the table). For example, the handler can check list of table names in query field 504 of each cache database record 500 in cache database 208 to determine if it contains at least one affected table name. Upon finding at least one affected table name in list of table names in query field 504 of a cache database record 500, the handler can invalidate or remove the corresponding cache database record 500 from cache database 208.

At step 910, the handler passes the database message to the intended database server and ends processing. In one embodiment, the handler may continue executing to receive any response messages from the database server and forward the received response message to the originator of the database message (i.e., a database client). For example, the handler may receive a confirmation message from the database server.

If, at step 904, the handler determines that the database message is not an update operation, the handler checks to determine if caching is enabled within result caching system 102 for this database message at step 912. For example, the handler can parse enough of the database message to determine that it is a database query operation. The handler can then extract from the database message the necessary information (i.e., the intended database server, the queried database, the requesting database user. the originating database client, the queried database table, etc.) to determine, using the caching hierarchy, if caching is enabled for this database query operation.

If, at step 912, the handler determines that caching is not enabled for the database query operation, the handler passes the database message to the intended database server at step 910. In one embodiment, the handler continues executing to receive a response message to the database query operation form the database server and forward the received response message to the database client that requested the database query operation. Furthermore, the handler may continue executing to process subsequent requests for additional information in instances where the data originally queried could not be provided in a single response message. Upon processing the database query operation, the handler ends processing.

In another embodiment, even though caching is not enabled for the database query operation, the handler may create a cache database record 500 in cache database 208 for the database query operation. The handler can then store the responses to the database query operation received from the database server in cache database record 500. Having created cache database record 500 for this database query operation, result caching system 102 can respond to a subsequent identical database query operation by using the cached responses if caching is subsequently enabled and there was not an intervening update operation to a table that is queried by the database query operation.

If, at step 912, the handler determines that caching is enabled for the database query operation, the handler normalizes the query text at step 914. At step 916, the handler checks cache database 208 to determine if there is a cache hit. For example, the handler compares the normalized query text with each tag (i.e., normalized query text field 502) until a match is found or it determines that a tag matching the normalized query text does not exist in cache database 208.

If, at step 916, the handler determines that there is a cache hit, the handler retrieves the response to the database query operation from cache database record 500 corresponding to the database query operation at step 918. The listener process then transmits the response retrieved from the corresponding cache database record 500 to the database client that requested the database query operation. At step 920, the listener process processes any subsequent requests for any remaining data associated with the database query operation and ends processing. The client process also retrieves from the corresponding cache database record 500 the appropriate response messages to the subsequent requests for the remaining data.

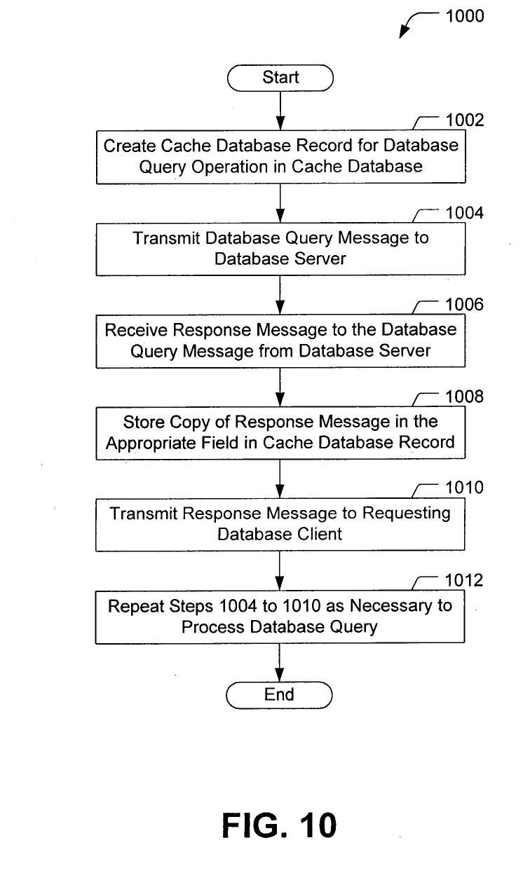

If, at step 916, the listener process determines that there is not a cache hit, but rather a “cache miss”, the handler initiates a cache entry for the database query operation at step 924 and ends processing. The handler builds a cache entry by creating a cache database record 500 that corresponds to the database query operation in cache database 208. FIG. 10 illustrates a flow chart of one embodiment of a method 1000 by which a handler creates an entry in cache database 208 for a database query operation.

Beginning at a start step, the handler creates a cache database record 500 in cache database 208 for the database query operation in step 1002. For example, the handler creates a cache database record 500 for the database query operation and stores in the appropriate fields of the record information derived from parsing segments of the database query message. At step 1004, the handler transmits the database query message to the intended database server (i.e., the database server capable of processing the database query message).

At step 1006, the handler receives a response message to the previously transmitted database query message from the database server. At step 1008, the handler stores a copy of the received response message in an appropriate field in cache database record 500 created for the database query operation. At step 1010, the handler transmits the received response message to the database client that requested the database query operation (i.e., the database client that transmitted the database query message). At step 1012, the handler repeats steps 1004 to 1010 as necessary to process subsequent requests for data which was not capable of being delivered in a prior request, and ends processing.

While certain embodiments of the invention have been described, these embodiments have been presented by way of example only, and are not intended to limit the scope of the present invention. For example, although the present invention has been described with reference to networked database systems, it should be recognized the invention is not so limited, and that the various aspects of the invention can be readily applied to non-networked database systems, as well as to other client/server applications where performance enhancement is an issue.

Accordingly, this invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A method, performed in a result caching system, for query result caching comprising:
providing a query result database comprising at least one query result record, each query result record associated with a query;
receiving from a requester a query request intended for a server;
determining if the query request is represented by a query result record in the query result database;
responsive to determining that the query result record representing the query request is found in the query result database, retrieving and transmitting to the requestor a query response to the query request, wherein the query response is retrieved from the query result database; and
responsive to determining that the query result record representing the query request is not found in the query result database, creating a new query result record representing the query request in the query result database and transmitting the query request to the server.

2. The method of claim 1 further comprising, responsive to determining that the query result record representing the query request is not found in the query result database and subsequent to transmitting the query request to the server, receiving a query response to the query request, storing the query response in the query result database, and transmitting the query response to the requester.

3. The method of claim 1 further comprising:
receiving from the requestor a non-query request intended for the server;
identifying and removing from the query result database all query result records affected by the non-query request;
transmitting the non-query request to the server; and
subsequent to transmitting the non-query request to the server, receiving a non-query response to the non-query request and transmitting the non-query response to the requester.

4. The method of claim 1, wherein each of the at least one query result records comprises a normalized query text, wherein the normalized query text corresponds to the query.

5. The method of claim 1, wherein the requestor is a database client.

6. The method of claim 1, wherein the server is a database server.

7. The method of claim 1, wherein the query request is a database query request.

8. The method of claim 1, wherein the server is remote from the result caching system.

9. The method of claim 1, wherein the determining if the query request is represented by a query result record in the query result database step is selectively performed based on the query request.

10. A computer-readable storage medium having stored thereon computer instructions that, when executed by a computer, cause the computer to:
receive from a requestor a query request intended for a server;
determine if the query request is represented by a query result record in a query result database, wherein the query result database comprises at least one query result record, each query result record associated with a query;
responsive to determining that the query result record representing the query request is found in the query result database, retrieve and transmit to the requestor a query response to the query request, wherein the query response is retrieved from the query result database; and
responsive to determining that the query result record representing the query request is not found in the query result database, create a new query result record representing the query request in the query result database and transmit the query request to the server.

11. The computer-readable storage medium of claim 10, wherein the query request is received via a network connection from the requestor.

12. The computer-readable storage medium of claim 10, wherein the query request is transmitted via a network connection to the server.

13. The computer-readable storage medium of claim 10, wherein the query request is a database query request.

14. The computer-readable storage medium of claim 10, wherein the requester is a database client.

15. The computer-readable storage medium of claim 10, wherein the server is a database server hosting at least one database.

16. The computer-readable storage medium of claim 10 further comprising computer instructions that, when executed by a computer, cause the computer to, responsive to determining that the query result record representing the query request is not found in the query result database and subsequent to transmitting the query request to the server, receive a query response to the query request, store the query response in the query result database, and transmit the query response to the requestor.

17. The computer-readable storage medium of claim 10 further comprising computer instructions that, when executed by a computer, cause the computer to:
receive from the requester a non-query request intended for the server;
identify and remove from the query result database all query result records affected by the non-query request;
transmit the non-query request to the server; and
subsequent to transmitting the non-query request to the server, receive a non-query response to the non-query request and transmit the non-query response to the requester.

18. The computer-readable storage medium of claim 10 further comprising computer instructions that, when executed by a computer, cause the computer to selectively determine if the query request is represented by a query result record in a query result database based on the query request.

19. A result caching system comprising:
a means for providing a query result database comprising at least one query result record, each query result record associated with a query;
a means for receiving from a requester a query request intended for a server;
a means for selectively determining whether to check to see if the query request is represented by a query result record in the query result database based on the query request;
responsive to determining that the query result record representing the query request is found in the query result database, a means for retrieving and transmitting to the requestor a query response to the query request, wherein the query response is retrieved from the query result database; and
responsive to determining that the query result record representing the query request is not found in the query result database or responsive to determining not to check to see if the query request is represented by a query result record in the query result database based on the query request, creating a new query result record representing the query request in the query result database and transmitting the query request to the server.

20. The result caching system of claim 19 further comprising:
a means for receiving from the requestor a non-query request intended for the server;
a means for identifying and removing from the query result database all query result records affected by the non-query request;
a means for transmitting the non-query request to the server; and
subsequent to transmitting the non-query request to the server, a means for receiving a non-query response to the non-query request and transmitting the non-query response to the requestor.

21. The result caching system of claim 19 further comprising a means for, subsequent to transmitting the query request to the server, receiving a query response to the query request, storing the query response in the query result database, and transmitting the query response to the requester.
